(19) United States
(12) Patent Application Publication
(10) Pub. No.: US 2019/0033473 A1
(43) Pub. Date: Jan. 31, 2019

(54) LAYERED PIXEL DETECTOR OF IONIZING RADIATION

(71) Applicant: ADVACAM S.R.O., Praha 7 (CZ)

(72) Inventor: Jan JAKUBEK, Hýskov (CZ)

(21) Appl. No.: 16/069,524

(22) PCT Filed: Jan. 24, 2017
(86) PCT No.: PCT/CZ2017/000001

§ 371 Date: Jul. 12, 2018

(30) Foreign Application Priority Data
Jan. 29, 2016 (CZ) PUV 2016-32052

(51) Int. Cl. G01T 1/24; G01T 1/20; G01T 3/08; G01T 3/06

(52) U.S. Cl. CPC G01T 1/242; G01T 3/06; G01T 3/08; G01T 1/2018

(57) ABSTRACT

The layered pixel detector (7) of ionizing radiation includes at least two semiconductor pixel particle counting detectors. Each detector consists of a sensor (1) connected to a readout chip (2), while the readout chip (2) on a part of its perimeter has a projecting section (8) with contact pads to connect conductors (3). The detectors form at least one segment (9) in which the pixel detectors are arranged into layers on top of each other. The thickness of the readout chips (2) is up to 200 μm and the thickness of the sensors (1) is up to 2000 μm. The layered detector (7) includes at least one carrying thermal conductive platform (10) provided with at least one supporting structure (5) to support at least one projecting section (8) of the readout chip (2).

### FIELD OF THE INVENTION

The invention relates to the field of detection of ionizing radiation by means of semi-conductor detectors.

### BACKGROUND OF THE INVENTION

Imaging techniques that use penetrating ionizing radiation have been increasingly applied in many fields of activities. They have been used for quality inspection and nondestructive testing in the industry, for diagnostic and therapeutic purposes in medicine, for inspection of luggage and consignments in security applications etc. The best known and the most widespread imaging technique is transmission radiography with X-ray or gamma radiation.

One specific area of imaging using penetrating ionizing radiation is neutron radiography. The principle of the method is very similar to X-ray radiography. It can be used in those cases where X-ray radiography fails to provide sufficient contrast, i.e. if X-ray radiation fails to sufficiently penetrate the material. In this case X-ray radiation can be replaced with neutron radiation with higher penetration power. Neutron transmission radiography makes it possible to get images of some light materials located inside heavier matrix. One example is imaging of distribution of organic materials inside metal or mineral structures, e.g. organic lubricants in machines, organic adhesives in glued metallic structures or e.g. water in mineral materials, explosives in a container etc.

All those imaging techniques use the ability of the employed type of ionizing radiation to penetrate through optically non-transparent objects to show their internal structure. Imaging detectors implementing such techniques always need to include an imaging sensor with an sensitive area detecting the incident ionizing radiation. The imaging sensor therefore particularly needs to intercept the penetrating radiation. As the employed radiation is able to penetrate the material it can also penetrate the imaging detector. Therefore, material and design of the sensor need to be specifically adapted to maximize detection efficiency for the given type of ionizing radiation, so that as many particles of the given ionizing radiation as possible, e.g. photons of X-ray radiation, should create a signal in the sensor.

Detection efficiency of an imaging detector depends on the material of the sensor and on its thickness. The requirement for high detection efficiency therefore usually leads to the requirement for big thickness of the imaging detector sensors. A disadvantage of this approach consists in the fact that thickness of the sensor adversely affects the resulting spatial resolution of the imaging detector. For this reason thick sensors with high efficiency fail to reach the resolving power of thin sensors with lower efficiency.

Imaging detectors detecting ionizing radiation are available in many forms. The oldest type of sensitive surface is a photosensitive film. In the digital era the most frequently used sensitive surfaces in imaging techniques are scintillation screens (e.g. CsI, Gadox, NaI(Tl), BGO, LYSO) which convert ionizing radiation into visible light and the light is subsequently recorded by a photo detector e.g. CCD or CMOS sensor. These systems thus use the principle of double conversion, which means that radiation is initially transformed by a scintillator into visible light and the light is then transformed by a photo detector into an electric signal. The electric signal is further processed with appropriate hardware or software to create an image on a screen or other imaging media.

In recent years semiconductor detectors using the principle of single conversion have been increasingly popular as sensors of ionizing radiation in which the incident ionizing radiation creates an electric signal directly in a semi-conductor element. One semi-conductor chip contains a high number of such elements, known as pixels, which form the imaging sensor. A signal from each of the elements is further processed with specialized hardware and software to create the final image. These semi-conductor detectors of radiation are referred to as semi-conductor pixel detectors or sensors and they are made of various semi-conductor materials, such as silicon, CdTe, GaAs etc.

For detection of penetrating neutron radiation a semi-conductor detector is often combined with a convertor. In semi-conductor detectors the convertor is placed in a thin layer on the top of its sensitive surface. The converters include e.g. a layer containing ⁶Li or ¹⁰B for detection of slow neutrons or organic polymer with high content of hydrogen for detection of fast neutrons. In the convertor the neutrons are converted into ionized radiation, which is subsequently detected by a sensor with high efficiency. In this case the sensor can be thin. A disadvantage of this solution consists in the fact that in practical cases the convertor layer has only very low efficiency in units of percents.

Hardware for processing of electric signals from the individual pixels is often created on an independent chip called a readout electronics chip or simply a readout chip. A sensing chip of a semi-conductor pixel detector is usually placed directly in the readout chip, covering it and being electrically connected to it with a contact matrix. Such a set of the two chips forms a permanent unit referred to as a hybrid semi-conductor pixel detector or briefly as a hybrid detector. The readout chip is often equipped along one of its sides with contacts to the so-called peripheries for power supply and communication lines. The reading sensor area with peripheries is usually not covered with the pixel sensor chip and so it is possible to connect external conductors. In some cases the reading electronics chip is designed to allow digital recording of information about each individual particle of ionizing radiation that has created an electric signal in the sensor. The resulting detector is then referred to as a “particle counting detector” or, if the particles are photons, e.g. in case of X-ray or gamma ionizing radiation, a “photon counting detector”. The main advantage of such detectors is the absence of integration and digitalization noise in the image.

Semi-conductor detectors Medipix2, Medipix3 and Timepix or Pilatus and Eiger are examples of hybrid semi-conductor particle counting detectors that are well known in the professional community. Thickness of the sensor chip usually ranges from 50 μm to 2000 μm, while thickness of the sensors preferably used for imaging is 300 μm and more. The sensors are mostly made of silicon crystals, less frequently CdTe or Cd(Zn)Te crystals and even more sporadically GaAs crystals. Individual pixels are usually square-shaped with the side length of 55 μm in case of the Medipix2, Medipix3 and Timepix chips, 75 μm in case of the Eiger chips and 172 μm in case of Pilatus chips, etc. The size of a pixel is therefore not the same for all hybrid semi-conductor detectors.

In most of existing types of detectors any attempts to achieve higher detection efficiency by increasing thickness of the sensitive layer lead to reduction of spatial resolution. The reason of this phenomenon in case of semi-conductor pixel detectors is expansion of a charge formed by the detected radiation particle in the sensor. In a thick sensor the charge needs to be transported through the thick semi-conductor to collecting electrodes of pixels. In the course of the process the charge expansion occurs and in the end the charge cloud created by one particle is registered in several adjacent pixels of the readout chip. In case of scintillation screens the problem is similar because, in case of a thick scintillator, a flash of scintillation light caused by a detected particle illuminates a group of pixels on a photodetector. In both cases the increasing thickness of the sensor causes degradation of spatial resolution of the detector.

A natural solution to this problem of detection efficiency is a layered detector made up of several thin detectors arranged into layers on top of each other. Penetrating radiation that is not captured in one layer will pass through to the other layers so the overall probability that radiation will be detected increases with the number of such layers. The resulting image is then composed of images captured by the individual detector layers. This solution is known for scintillation detectors. One disadvantage of this solution in the case of scintillation detectors consists in the fact that images from the individual layers are summed up to form an overall image but it also means accumulation of noise from all the layers.

Therefore it is convenient to use the layered technique with semi-conductor particle counting detectors that have significantly lower noise. The best results are achieved if the layers are arranged as close as possible to each other to avoid any geometrical distortion of the resulting composed image.

The presence of any other material between the tightly arranged sensitive layers of semi-conductor pixel particle counting detectors is problematic. Typically, such problematic materials include a readout electronics chip, printed circuit, mechanical structure of the layer holder, structure for heat removal from the layer, etc. Such additional problematic material is not sensitive to the radiation that passes through but it can significantly attenuate or disperse the radiation or it can produce secondary radiation, e.g. by X-ray fluorescence or Compton effect in the case of gamma or X-ray radiation, or producing delta electrons in the case of ion radiation or braking radiation etc. Presence of such non-sensitive problematic material is therefore undesired because it deteriorates sensitivity and resolving power of the layered detector. Such non-sensitive material also increases the distance between the sensitive layers, which may lead to geometric distortion and blurring of the composed image.

The objective of the invention is to create a layered pixel detector of penetrating ionizing radiation which would eliminate shortcomings of the known solutions of detectors of penetrating ionizing radiation in order to achieve high detection efficiency and also high spatial resolution with only negligible image deformation.

### SUMMARY OF THE INVENTION

The outlined objective is resolved by creation of a layered pixel detector of ionizing radiation under this invention.

The layered pixel detector of ionizing radiation consists of at least two semi-conductor pixel particle counting detectors, while each of them consists of a sensor connected to a readout chip. On the side of the readout chip there is a projecting section on a part of its perimeter with contacting pads to connect conductors.

The summary of the invention consists in the fact that pixel detectors form at least one segment in which the pixel detectors are arranged in layers on top of each other and that there is adhesive between the individual layers. The segment therefore forms a solid part of the layered detector, the adhesive conducts heat well between the layers and it affects the ionizing radiation very little because its layer is very thin. The thickness of readout chips is reduced with the maximum of 200 μm because thicker layers would significantly limit penetration of ionizing radiation. The thickness of sensors is limited with the maximum of 2000 μm because thicker sensors would disperse detection of particles into several pixels. Layering provides 3D sensitivity of the detector because the detector does not register the positions of incident particles only in a plane but also in a column. At the same time, the projecting sections of the subsequent layers, when viewed perpendicularly to the sensor plane, partly overlap or do not overlap and thus they provide support for higher layers that are not shielded by projecting parts of the lower layers. A layered detector also includes at least one carrying heat-conducting platform with at least one supporting structure to support at least one projecting part of the readout chip. The platform forms a support for the individual layers, it also operates as a carrying structure of the layered detector and it also distributes heat from the segment into a bigger area. The irregular arrangement of the projecting parts also helps to transfer heat from the segment into the surrounding air similarly as in a ribbed cooler.

In a preferred embodiment of the layered pixel detector under this invention the ground plan of the sensor and the ground plan of the readout chip without the projecting section are square-shaped. The square shape is easy to produce, it is easy to work with and the designs for square-shaped semi-conductor detectors are easier to make.

In another preferred embodiment of a layered pixel detector under this invention is a layered detector with at least two carrying thermal conductive platforms, while at least one of the carrying thermal conductive platforms is provided with an opening of an appropriate shape and size to place the sensor in the highest layer of the following segment on the readout chip in the bottom layer of the previous segment. If the platform is continuous its material would influence the penetrating ionizing radiation which would reduce the efficiency and accuracy of the detector. As the segments are smoothly connected to each other it is possible to create a layered detector of any height which is suitable for applications where we need to determine spatial distribution of ionizing radiation in 3D.

In another preferred embodiment of the layered pixel detector under this invention the carrying thermal conductive platforms are provided with a printed circuit to connect readout chips and a control unit. By moving the electronic parts into the platform all obstructing conductive material is removed from the segments of the layered detector.

In another preferred embodiment of the layered pixel detector under this invention the adhesive is polymer-based and it contains primarily light elements. The polymer adhesive consists of light elements that influence ionizing radiation only marginally and maintaining its main function of strong connection between the layers in the segment.

In another preferred embodiment of the layered pixel detector under this invention at least one neutron convertor is inserted between the individual layers. The neutron convertor converts incident neutrons into ionizing radiation of a different type that is easier to detect and leads to a better resulting image of the ionizing radiation. It is also convenient to create the neutron convertor for slow neutrons using ⁶LiF or ¹⁰B₄C powder fixed in polymer adhesive.

In another preferred embodiment of the layered pixel detector under this invention at least one sensor in the direction from the top layer has a higher absorption capacity than a sensor in the previous layer. In the X-ray radiography, in order to expand spectral sensitivity and dynamic range of the detector, it is convenient to arrange the sensors in layers so that their absorption ability gradually increases. For X-ray radiography it is convenient to use the least absorbing sensor in the first layer, a more absorbing sensor in the next layer, etc., and the most absorbing material only in the last layer.

In another preferred embodiment of the layered pixel detector under this invention the sensors in at least one adjoining pair of the layers are facing each other. A convertor described above can be situated between such adjoining sensors. In this configuration it is possible to conveniently combine events detected in the adjoining layers. This concerns, for example, detection of events in which X-ray fluorescence occurs in one sensor and fluorescence photons are detected in the other, or detection of a slow neutron in the conversion layer containing ⁶Li and its differentiation from events caused by energy ions. Energy ions, such as protons and alpha particles, cannot penetrate deeper layers of the detector without creating a signal in the first layer. However, neutrons penetrate the first layer without any interaction.

In another preferred embodiment of the layered pixel detector under this invention the segments are arranged side by side, while sensor surfaces form a continuous line and the projecting parts of readout chips are arranged along the line. To create a layered detector with an enlarged surface it is convenient to arrange the segments not only on top of each other but also side by side and thus to create a layered detector with a larger surface. The convenient arrangement of the segments is represented particularly by the row having its maximal length not limited.

Advantages of the layered pixel detector of ionizing radiation include high resolution, high detection efficiency and 3D sensitivity. The layered detector is convenient for applications in transmission X-ray and gamma radiography, energy sensitive transmission radiography, suppression of Compton scattering in transmission radiography, gamma cameras, Compton camera for gamma radiation, emission radiography with gamma radiation, ion detection and tracking, transmission neutron radiography, multimodal imaging or radiation monitoring. Layered detectors are stable, the load from the individual layers is distributed into the carrying platform, while the occurrence of many thermal bridges helps to remove excessive heat. The layers can be square-shaped or they can have another appropriate shape, while the number of layers and/or the length of a row is not limited.

### CLARIFICATION OF THE DRAWINGS

The invention hereunder is described in detail in the following figures, where:

FIG. 1 is an axonometric top view of a layered pixel detector,

FIG. 2 is a lateral cross section of a layered detector with two separated segments,

FIG. 3 is an axonometric top view of a layered pixel detector forming a line,

FIG. 4 is a lateral cross section of a layered detector with two separated segments, with two layers.

### EXAMPLE OF THE PREFERRED EMBODIMENTS OF THE INVENTION

It is understood that the below described and depicted particular cases of embodiment of the invention are presented for illustration and not to limit the invention to such examples. Those skilled in the art will find or will be able to provide, based on routine experimenting, one or more equivalents of the embodiments of the invention disclosed herein. Such equivalents shall be included into the scope of the following claims.

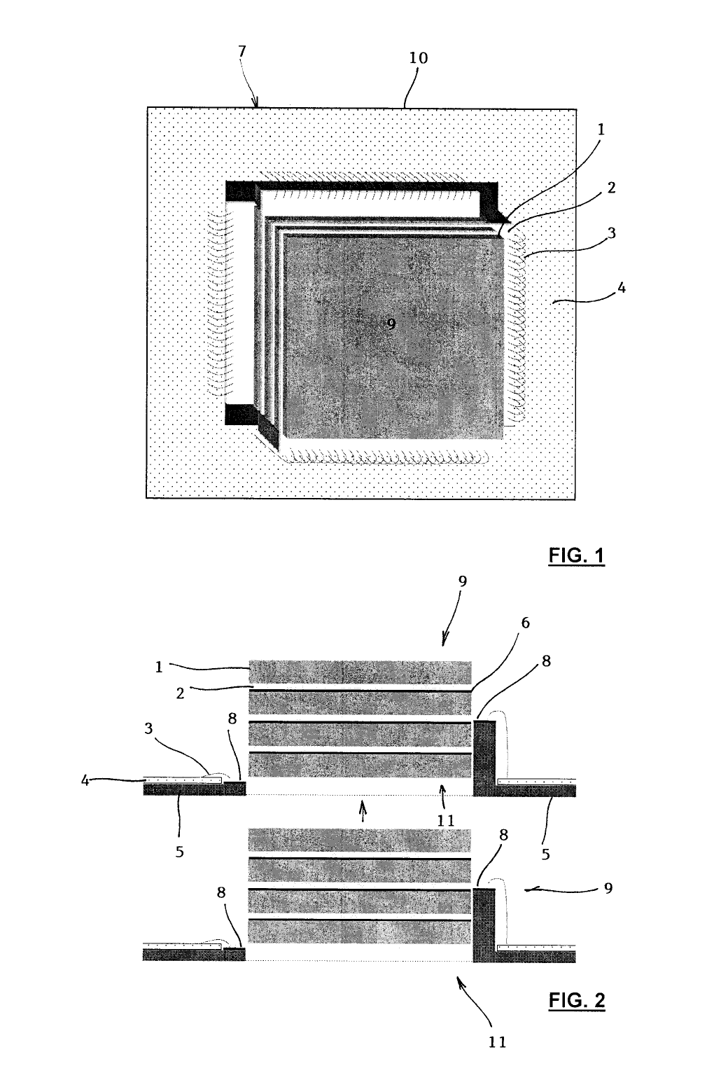

FIG. 1 shows a layered pixel detector 7 of ionizing radiation. On a carrying thermal conductive platform 10 made of aluminum there is a segment 9 made up of layers of semi-conductor pixel particle counting detectors. In each layer there is a sensor 1 made of silicon or

CdTe or GaAs material. The thickness of the sensor 1 shall not exceed 2000 μm. The maximum thickness of a readout chip 2 is 200 μm.

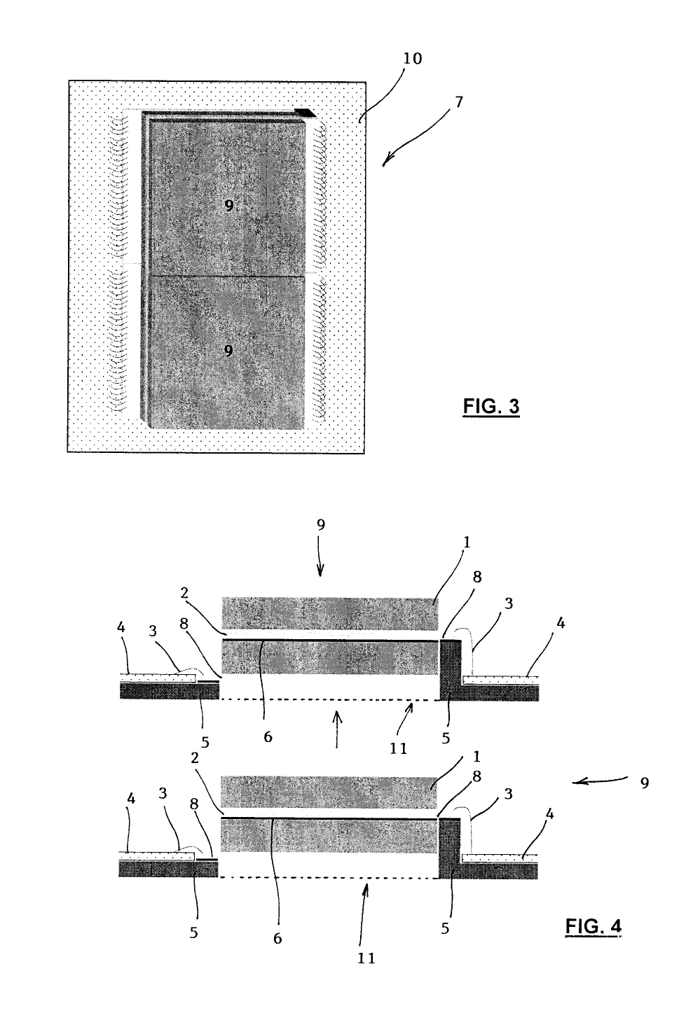

FIG. 2 shows a lateral cross section of the layered detector 7 in which there are two segments 9 prepared for connection. The segments 9 are made of layers of a silicon sensor 1 and a readout chip 2, while the individual layers are glued together with polymer adhesive 6 e.g. epoxy. Each readout chip 2 has a projecting part 8 with contact pads to connect conductors 3. The conductors 3 are wires connected to a printed circuit 4, which is connected to a control unit—computer (not shown in the figure). Each projecting part 8 is supported with a supporting structure 5 made of the same material as the platform 10 which transfers the load to the carrying thermal conductive platform 10. FIG. 3 shows an example of a layered detector 7 in the shape of a line and FIG. 4 shows a cross section through the segments 9 with two layers.

### Example of Use 1—Transmission X-Ray and Gamma Radiography

The basic application of the layered detector 7 is in transmission radiography with penetrating gamma or X-ray radiation for nondestructive testing in the industry and in diagnostics in medicine, where the radiation dose can be significantly reduced thanks to the high sensitivity. The detectors can be used also in security applications, such as scanning of consignments and luggage. The compact dimensions of the layered detector 7 can be conveniently used in radiography with the layered detector 7 placed inside the tested object. In the industry it can be used e.g. for inspection of cylinder walls in combustion engines, pipe welds etc., in medicine is can be used e.g. for prostate radiography with the layered detector 7 placed in a rectal probe.

### Example of Use 2—Energy-Sensitive Transmission Radiography

The most commonly used source of X-ray radiation in X-ray transmission radiography is an X-ray tube. This source provides X-ray radiation with a broad energy spectrum. In the case of radiography the soft component of the radiation (with lower energy) is absorbed in the sample more easily because it is less penetrating, while the harder component (with higher energy) passes through the sample. This phenomenon is referred to as hardening of the ionizing radiation spectrum. The spectrum hardening depends on density and material composition of the sample. The layered detector 7 has the possibility to measure the degree of spectrum hardening thanks to its 3D sensitivity. Lower energy (i.e. less penetrating) component of the spectrum is recorded in outer layers of the detector 7, while high energy (more penetrating) component get into deeper layers of the detector 7. Radiographic pictures captured by different layers of the detector 7 therefore contain information about the sample composition. The composition may be represented in the resulting image that comes out from the control unit e.g. by means of colors.

### Example of Use 3—Suppression of Compton Scattering in Transmission Radiography

In the course of X-ray and gamma radiography the image is often distorted as a result of Compton scattering in the detector volume. Compton scattering means that a gamma photon transfers a part of its energy to an electron which creates a signal in the sensor 1 in the place of scattering. The scattered photon continues to travel in a different direction with reduced energy and therefore it may create another signal at a different place of the sensor 1 where the whole process may repeat. One photon can be therefore detected at several places of the sensor 1, which causes distortion of the image because the scattered photons can contribute to places in the image that were not hit by the primary photons. In a layered pixel detector 7 such events can be excluded thanks to its high resolution and 3D sensitivity. In case of a multiple detection and if there is a signal in several pixels and/or layers at the same time the control electronics may either completely eliminate the event or keep only the first interaction. For implementation of this function it is convenient to use fast electronics in the design of the layered detector 7, which is available e.g. in the readout chip 2 of the detector known as Timepix3.

### Example of Use 4—Gamma Camera

The big detection efficiency of the layered detector 7 can be conveniently used to design a gamma camera used for monitoring and detection of gamma sources in the environment. It uses the principle referred to as “camera obscura”. In this configuration the layered detector 7 is equipped with an input collimator, such as a “pin-hole” or the so-called coded aperture and shielding which insulates it from irradiation from other directions than those defined by the collimator.

### Example of Use 5—Compton Camera for Gamma Radiation

3D sensitivity of the layered detector 7 can be used to design a Compton camera. In this configuration each layer is provided with a readout chip 2 that allows to measure deposited energy for each interaction of radiation with the material of the sensor 1. The most probable type of interaction of hard X-ray or gamma radiation with the materials of the sensor 1 is Compton scattering. For one primary photon there can be several scattering events in a series on the layered detector 7 before all the energy of the primary photon is absorbed. The layered detector 7 makes it possible to record the whole chain of such interactions. Thanks to the high resolution and 3D sensitivity it is highly improbable that several interactions might occur within one pixel. If we record the position and deposited energy for each interaction in the chain then it is possible making a reverse calculation of the angle of the primary photon when it entered the layered detector 7. Records of many such primary photons allow to calculate an image of distribution of the radiation sources in the space, including their spectrums without the use of collimators.

### Example of Use 6—Emission Radiography with Gamma Radiation

In emission radiography the imaged object contains radiation sources. The purpose of the radiography is to show distribution of the sources in the object volume. The method is frequently used in medicine when a radioisotope is introduced into the organism in a form allowing to monitor its movement in the body and to draw conclusions about functioning of certain organs. The imaging methods are called scintigraphy (2D imaging) and SPECT or PET (3D imaging). When performing this method it is desirable that gamma radiation emitted by radioisotopes should not be absorbed in the organism but it should leave it. For this reasons the preferred radioisotopes are those producing penetrating gamma radiation with high energy. The use of the layered detector 7 is therefore very convenient thanks to its high detection efficiency. For this reason it is possible to use the above-described configuration, such as the gamma camera and Compton camera.

### Example of Use 7—Detection and Tracking of Ions

3D sensitivity of the layered pixel detector 7 can be also used for detection of energetic ions and for determination of their flight direction. The ions penetrate layers of the detector 7 mostly along a line and they create a signal in each layer traversed. Meanwhile, the energy of the ion gradually decreases and it may stop completely. A reverse calculation may be then used to determine the angle under which the ion entered the layered detector 7 and, in many cases, also its energy and/or weight. Those properties can be then very well applied in monitoring of ion therapy (e.g. proton therapy or carbon therapy) or for imaging with energetic ions, e.g. proton CT.

### Example of Use 8—Transmission Neutron Radiography

In neutron radiography a layered pixel detector 7 modified for detection of neutron radiation provides better spatial resolution and higher detection efficiency than most of the existing solutions. For slow neutrons the spatial resolution is in units of micrometers with the detection efficiency in tens of percents. Between the layers the convertor is formed by the adhesive 6 containing crushed ⁶LiF or ¹⁰B₄C or only by a thicker layer of the adhesive 6.

### Example of Use 9—Multimodal Imaging

A layered pixel detector 7 allows to discern individual types of radiation and in some cases it is even possible to identify their energy spectra and other properties. In the course of one measurement it is thus possible to create several images corresponding to the individual types of radiation and their properties.

### Example of Use 10—Radiation Monitoring

In the layered detector 7 there are often unique chains of interactions for different radiation types. The layered pixel detector 7, thanks to its 3D sensitivity, makes it possible to differentiate between such types of interactions. The energetic ions penetrate the detector along a straight line and they create a typical signal in each of its layers. For detection of neutrons the layered detector 7 is equipped with a neutron convertor in each layer, except in the first one.

### INDUSTRIAL APPLICABILITY

The layered pixel detector under this invention can be used in medicine, industry, security applications, as well as in research.

### OVERVIEW OF THE POSITIONS USED IN THE DRAWINGS

1 sensor
2 readout chip
3 contacts
4 printed circuit
5 supporting structure
6 adhesive
7 layered pixel detector
8 projecting section
9 segment
10 carrying thermal conductive platform
11 opening in the carrying thermal conductive platform

1. A layered pixel detector (7) of ionizing radiation including at least two semi-conductor pixel particle counting detectors, each consisting of a sensor (1) connected to a readout chip (2), while on the side of the readout chip (2) there is a projecting section (8) along a part of its perimeter with contact pads to connect conductors (3), characterized in that the pixel detectors form at least one segment (9), in which the pixel detectors are arranged into layers one over another with adhesive between the individual layers (6), the thickness of readout chips (2) is up to 200 μm, the thickness of sensors (1) is up to 2000 μm, where the projecting parts (8) of adjoining layers, when viewed in perpendicular direction to the sensor area (1), partly overlap or do not overlap and the layered detector (7) includes at least one carrying thermal conductive platform (10) provided with at least one supporting structure (5) to support at least one projecting part (8) of the readout chip (2).

2. A layered pixel detector according to claim 1 characterized in that the ground plan of the sensor (1) and the ground plan of the readout chip (2) without the projecting section (3) are of the square shape.

3. A layered pixel detector according to claim 1 characterized in that it includes at least two carrying thermal conductive platforms (10), while at least one load bearing thermal conductive platform (10) is provided with an opening (11), of an appropriate shape and size enabling to position two layered detectors on top of each other that way that the sensor (1) in the top most layer of the second layered detector (9) is placed behind the readout chip (2) of the bottom layer of the first layered detector (9).

4. A layered pixel detector according to claim 1 characterized in that the carrying thermal conductive platforms (10) are provided with a printed circuit (4) to connect conductive connections (3) and the control unit.

5. A layered pixel detector according to claim 1 characterized in that the adhesive (6) is polymer-based and contains primarily light elements.

6. A layered pixel detector according to claim 1 characterized in that at least one neutron convertor is inserted between its individual layers.

7. A layered pixel detector according to claim 6 characterized in that the neutron convertor is made of ⁶LiF or ¹⁰B₄C filled adhesive (6).

8. A layered pixel detector according to claim 1 to characterized in that at least one sensor (1) in the direction from the top layer down has a higher absorption than the sensor (1) in the previous layer.

9. A layered pixel detector according to claim 1 characterized in that at least in one adjoining pair of layers the sensors (1) are facing each other by sensor sides.

10. A layered pixel detector according to claim 1 characterized in that the segments (9) are arranged side by side, while surfaces of the sensors (1) form a continuous row and the projecting sections (8) of the readout chips (2) are arranged along the row.
